(19) United States
(12) Patent Application Publication
(10) Pub. No.: US 2014/0014778 A1
(43) Pub. Date: Jan. 16, 2014

(54) Inflatable Kite with Leading Edge Swept Forwards at Wingtip

(71) Applicant: Ross Harrington, Victoria (CA)

(72) Inventor: Ross Harrington, Victoria (CA)

(21) Appl. No.: 13/521,790

(22) PCT Filed: Feb. 1, 2012
(86) PCT No.: PCT/CA2012/000115

§ 371 Date: Sep. 30, 2013

Related U.S. Application Data
(60) Provisional application No. 61/438,873, filed on Feb. 2, 2011.

(51) Int. Cl. B64C 31/06

(52) U.S. Cl. CPC B64C 31/06
USPC 244/154

(57) ABSTRACT

An inflatable kite has a continuous leading edge tube that is swept forward at its left and right wingtip ends so that bridle lines attaching the canopy to the user are forward of the centre of effort of the kite.

### TECHNICAL FIELD

This invention is related to kites used in the sport of kite boarding and more specifically to an inflatable kite having a leading edge swept forwards at the wingtip.

### BACKGROUND ART

Kite surfing or Kite boarding is a surface water sport that uses the wind to pull a rider through the water on a small surfboard or a kite board (similar to a wakeboard). The terms kite boarding and kite surfing are interchangeable. There are a number of different styles of kite boarding, including freestyle (most common and utilizes standard kite and board) or wake-style (flatter water using board with bindings) and wave-riding which is focused on big waves using a board designed for wave riding.

A kite surfer or kite boarder uses a board with or without foot-straps or bindings, combined with the power of a controllable kite to propel the rider and the board across the water. Riding styles have evolved to suit riders and conditions, such as wake style, wave riding, freestyle, free ride, jumping, and cruising.

The sport is becoming somewhat safer due to innovations in kite design, safety release systems, and instructions, however there are numerous deaths every year, and injuries due to body drag on land and water, hitting obstacles on land or water, or getting entangled in the lines.

All modern kites dedicated to kite surfing provide a ‘depower’ option to reduce the power in the kite. By using depower, the kite's angle of attack to the wind is reduced, thereby catching less wind in the kite and reducing the power or pull.

A person practicing kite boarding is usually connected to the kite by means of a central line attached to a harness the user wears. This central line splits into two lines at some point above the control bar and these two lines, called front lines, attach to the front bridles on the kite, or on kites without bridles they attach directly to the leading edge of the wingtip. The side-lines, called back lines, connect to the outside ends of the control bar, which is held in the user's hands, and to the rear bridle on the kite or on kites without a bridle they attach directly to the trailing edge of the wingtip. The user's pulling or pushing the control bar towards or away from the harness alters the kite's angle of attack relative to the wind, causing an increase or decrease in the pulling force of the kite. Pulling the right side of the steering bar towards the user turns the kite to the right. Pulling the left side of the steering bar towards the user turns the kite to the left. All kites with a central control line passing through the middle of the control bar are controlled in the way described above.

### DISCLOSURE OF INVENTION

### Technical Problem

FIGS. 1 to 6 illustrates examples of prior art leading edge inflatable kites (LEI). In FIG. 1, a LEI kite (1) is illustrated having an inflatable leading edge tube (2) swept rearwards at the wingtips (16). The kite comprises a canopy (4), struts (6), bridle attachments (8) on the leading edge tube (2), bridle lines (10), a front tow point (12), a wingtip front bridle attachment (30), a rear tow point (14), a rear wingtip bridle attachment (32), a wingtip (16) having a rounded plan form outline (26) and a center of effort (20). FIG. 2 illustrates a similar LEI kite (1) having a wingtip (16) having a truncated plan form outline (28). FIG. 3 shows a different embodiment of the LEI kite (1) of FIG. 2 in which the top end of the inflatable edge tube (2) is swept forward at the centre. FIG. 4 is a top view of the prior art LEI kite of FIG. 1. FIG. 5 is a top view of the prior art LEI kite of FIG. 2. FIG. 6 is a top view of the prior art LEI kite of FIG. 3.

In these prior art embodiments improvements can be made to aerodynamic efficiency by moving the wingtip front bridle attachment forwards, as this will move the front tow point forwards in relation to the center of effort. This will increase the amount that the rider is able to decrease the angle of attack of the kite, thus increasing the depower capability. However, as the prior art figures show, to move the wingtip front bridle attachment (30) further forwards means it must be moved further up the leading edge tube. This makes it hard to properly support the leading edge arc and prevent it from collapsing while under load. This can also cause the section of the leading edge tube that goes from the wingtip front bridle attachment to the wingtip rear bridle attachment to buckle while under load or when turning the kite. Another option is to decrease the amount that the leading edge tube is swept rearwards however this has a negative effect on the relaunch capability of the kite, when crashed on the water, and it decreases the amount of depower as it moves the center of effort on the kite forwards.

Therefore, there is a continued need for an LEI kite to have improved aerodynamic and re-launch capabilities by back-sweeping the inflated leading edge of the kite while at the same time being able to move the front tow points more forwards without having to move the wingtip front bridle attachment higher up on the leading edge tube.

### DESCRIPTION OF DRAWINGS

FIG. 1—Side view of prior art kite with rounded wingtips.

FIG. 2—Side view of prior art kite with truncated wingtips.

FIG. 3—Side view of prior art kite with leading edge swept forwards at center.

FIG. 4—Top flat view of prior art kite with rounded wingtips.

FIG. 5—Top flat view of prior art kite with truncated wingtips.

FIG. 6—Top flat view of prior art kite wing leading edge swept forwards at center.

FIG. 7—Perspective view of kite with leading edge swept forward at wingtips and ends of wingtips rounded.

FIG. 8—Perspective view of kite with leading edge swept forward at wingtips and ends of wingtips truncated.

FIG. 9—Side view of kite with leading edge swept forward at wingtips and ends of wingtips rounded.

FIG. 10—Side view of kite with leading edge swept forward at wingtips and ends of wingtips truncated.

FIG. 11—Top flat view of kite with leading edge swept forward at wingtips and ends of wingtips rounded.

FIG. 12—Top flat view of kite with leading edge swept forward at wingtips and ends of wingtips truncated.

FIG. 13—Perspective view of kite with leading edge swept forward at wingtips that only has bridles on wingtip.

FIG. 14—Side view of kite with leading edge swept forward at wingtips showing relationship between front tow point and center of effort.

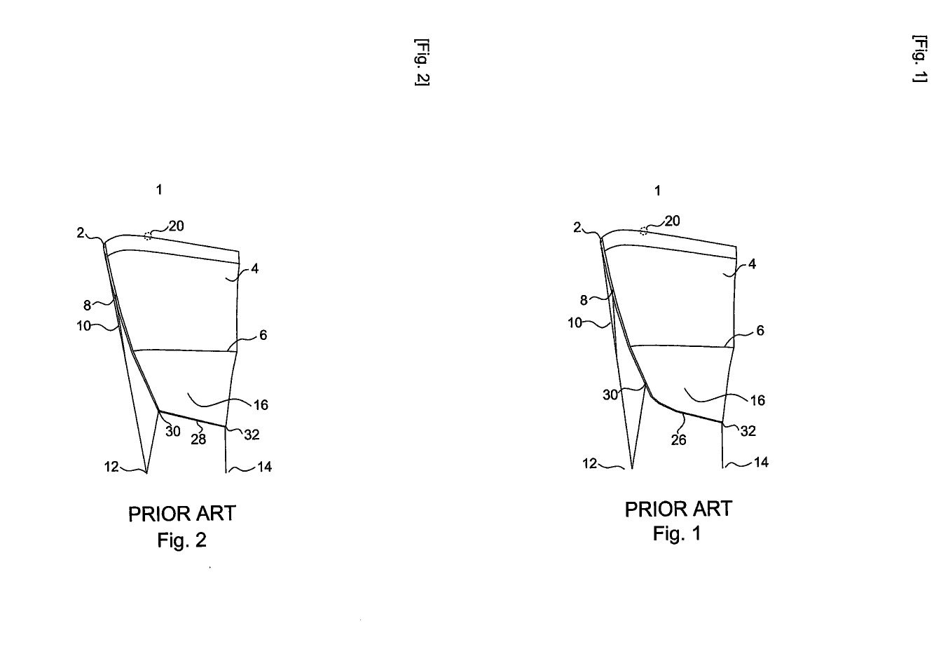

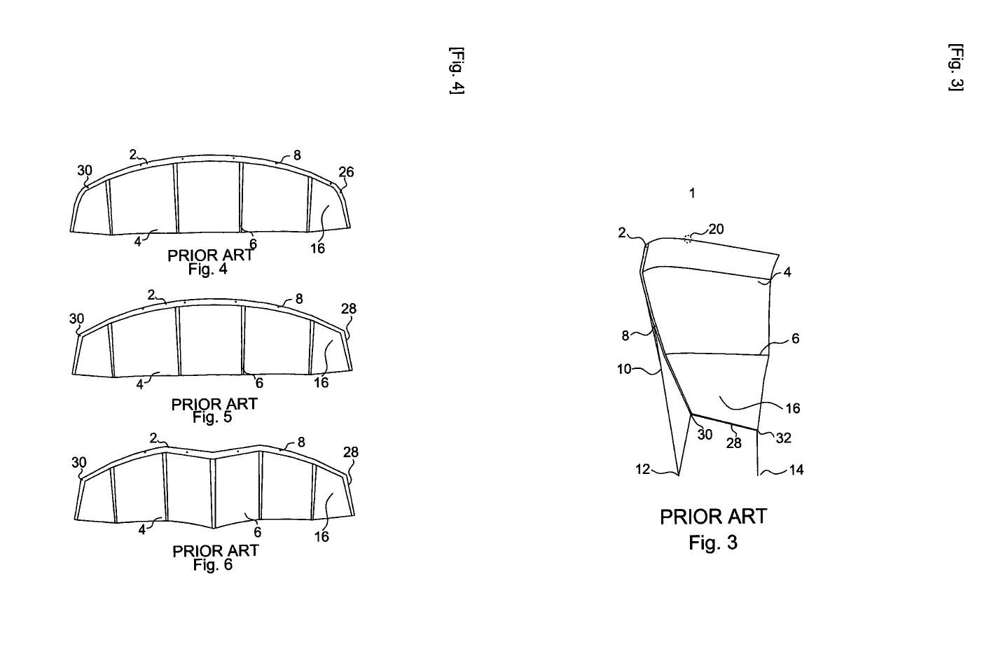

### BEST MODE

### Description of Figure Numbers

1—Kiteboarding kite
2—Inflated leading edge tube
4—Canopy
6—Strut
8—Bridle attachment on leading edge tube
10—Bridle line
12—Front tow point
14—Rear tow point
16—Wingtip
18—Forward swept section of leading edge at wingtip
20—Center of effort
22—Vertical line showing positioning of center of effort on side view of kite
24—Horizontal distance from front tow point to center of effort
26—End of wingtip rounded
28—End of wingtip truncated
30—Wingtip front bridle attachment
32—Wingtip rear bridle attachment

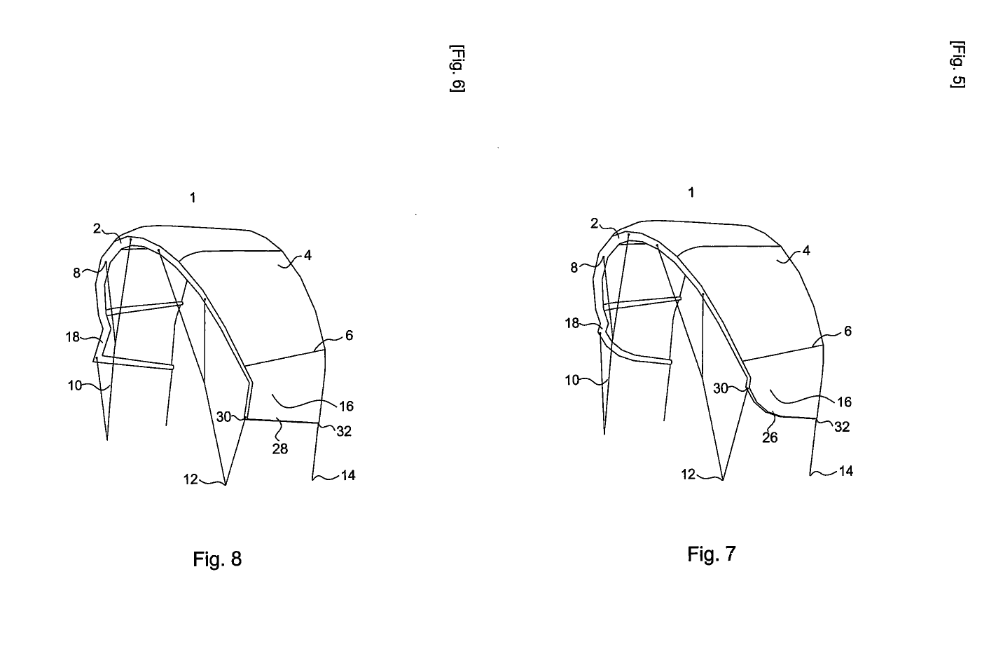

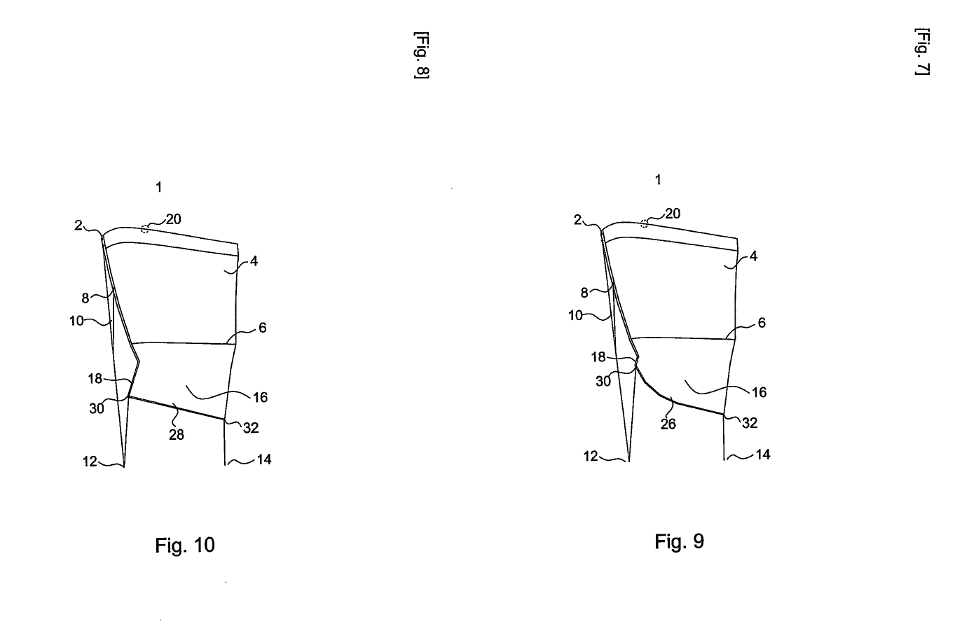

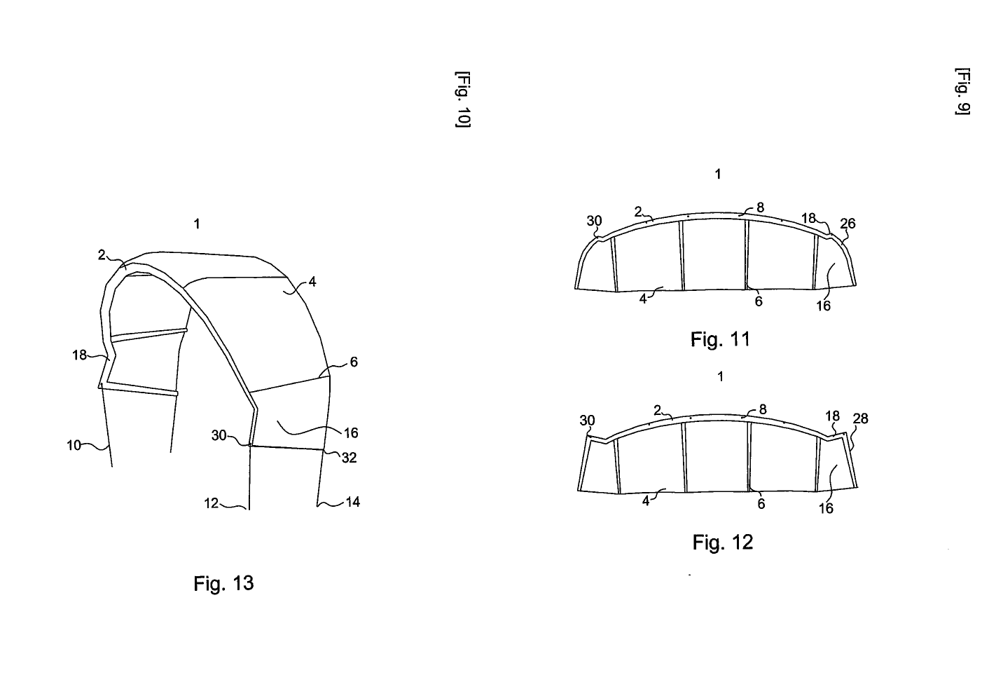

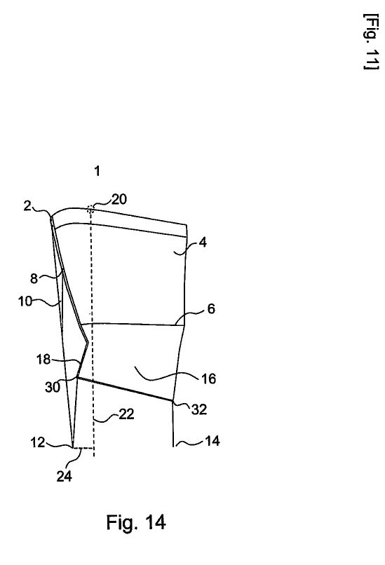

Referring to FIGS. 7 to 14 there is shown various view of a preferred embodiment of the invention which is an LEI kite (1) with the inflated leading edge tube (2) swept forwards (18) at wingtip so that the wingtip bridle attachment (30) is moved forwards on the leading edge tube (2). The front tow point (30) is forward of the center of effort (20) of the kite wing thus increasing the depower capabilities of the kite.

The kite (1) comprises a canopy (4) supported by a plurality of parallel struts (6). The leading edge tube runs between the two rear connection points (32) on either side of the canopy. The rear bridle attachments are located at attachment points (32) and the front bridle attachment points are located on the leading edge tube at (30) and (8). The front bridle lines (10) converge at front tow point (12) and the rear bridle lines converge at rear tow point (14). The wingtip (16) has a rounded edge (26) comprising a swept back portion of the inflatable leading edge tube (2). Just prior to the swept back portion (26) of the wingtip, the leading edge portion (18) is swept forward so that the bridle line attachment points (30) are forward of the center of effort (20) of the kite.

FIG. 17 shows the horizontal distance from the front tow point (24) to a vertical line showing the position of the center of effort (22).

1. An inflatable kite with leading edge swept forward at the wingtips comprising a canopy sheet, a leading edge and a trailing edge, a left edge and a right edge; a canopy supporting frame assembly attached to canopy comprising an inflatable leading edge tube attached to said leading edge, said left edge and said right edge and struts disposed between said leading edge and said trailing edge.

2. The inflatable kite of claim 1 having wingtip bridle attachments located on the swept forwards section of the wingtips.

3. The inflatable kite of claim 2 wherein said the bridle lines on the leading edge tube and the bridle on the forwards swept section of the wingtip converge to a front tow point.

4. The inflatable kite of claim 1 wherein the front flying lines connect directly to the attachments on the forwards swept section of the wingtips.
